(19) United States
(12) Patent Application Publication
(10) Pub. No.: US 2005/0140136 A1
(43) Pub. Date: Jun. 30, 2005

(54) Hose lock apparatus for vacuum cleaner

(75) Inventor: Byung-Jo Lee, Gwangju-city (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 10/896,849

(22) Filed: Jul. 23, 2004

(30) Foreign Application Priority Data
Dec. 30, 2003 (KR) 2003-0100431

(51) Int. Cl. F16L 33/22

(52) U.S. Cl. 285/7; 285/360

(57) ABSTRACT

A hose lock apparatus that provides easy attachment and detachment of a hose to an air inlet of a vacuum cleaner body. The hose lock apparatus includes a hose clamp substantially in a hollow cylindrical shape, and receiving an end of the hose therein. The hose lock apparatus further includes a locking protrusion formed along an outer circumference and a clamp holder securely attached to the air inlet. The clamp holder includes a connecting hole for receiving the hose clamp therein to connect the hose in fluid-communication to the air inlet, An insertion hole in the connecting hole guides insertion of the locking protrusion, and a seating groove receives the locking protrusion therein, and is in fluid-communication with the insertion hole. When inserting the hose clamp into the connecting hole of the clamp holder and rotating the hose clamp predetermined angles, the locking protrusion is positioned in the seating groove and thereby, the hose clamp is securely attached to the clamp holder.

### REFERENCE TO RELATED APPLICATION

This application claims priority to copending Korean Patent Application No. 2003-100431 filed on Dec. 30, 2003, in the Korean Intellectual Property Office, the disclosure of which is incorporated herein by reference in its entirety.

### CROSS-REFERENCE TO RELATED APPLICATION

This application is related to the copending application entitled “Hose Lock Apparatus For Vacuum Cleaner”, (Korean Patent Application No. 2003-101478 filed Dec. 31, 2003), which disclosure is commonly owned by the same assignee as the present application and is entirely incorporated herein by reference.

### FIELD OF THE INVENTION

The present invention relates to a hose lock apparatus for a vacuum cleaner, and more particularly to a hose lock apparatus for vacuum cleaners which provides easy attachment and detachment of the hose to the vacuum cleaner body.

### BACKGROUND OF THE INVENTION

A general vacuum cleaner creates in the well-known manner a partial vacuum by a rotating impeller in its body, drawing in and entraining air. The vacuum cleaner includes a flexible hose connected to its body to provide a passage for air and dust from specific areas. Particularly, an upright-type vacuum cleaner, which is one variant type of the vacuum cleaner, generally includes a hose of an air inlet at a rear portion of the vacuum cleaner body that is connected in fluid-communication to an auxiliary brush to conveniently clean crevices such as stairs or corners of the room.

FIG. 1 is a view illustrating an example of the upright-type vacuum cleaner with a hose for the auxiliary suction brush at the rear end of the vacuum cleaner body. FIG. 2 is a view illustrating a hose lock apparatus for a vacuum cleaner according to the prior art.

The hose lock apparatus 10 for the vacuum cleaner includes a hose clamp 12, a clamp holder 14 secured to the vacuum cleaner body 1, and a clamp connector 16 fixing the clamp 12 to prevent separation from the clamp holder 14. The hose clamp 12 is shaped as an angular pipe of 90 degrees and includes a hose 3 locked at an end. The other end of the hose clamp 12 is inserted in the clamp holder 14 so that the hose clamp 12 is connected in fluid-communication to the air inlet of the vacuum cleaner body. The hose clamp 12 includes a locking means at the outer side to lock the clamp connector 16.

The clamp holder 14 includes an opening 15 to receive the other end of the hose clamp 12, and is secured to the vacuum cleaner body 1 by connecting two screws 18 through two screw holes formed near the hole 15. The clamp connector 16 locks the hose clamp 12 to prevent separation from the clamp holder 14, and is locked at the hose clamp 12 by the locking means of the other end of the hose clamp 12.

The process for attaching the hose lock apparatus 10 with the above construction to the vacuum cleaner body 1 is described herein. First, the hose 3 is assembled to one end of the clamp 12. The clamp holder 14 is inserted into the other end of the hose clamp 12 and the clamp connector 16 is also inserted into the other end of the hose clamp 12 to lock the clamp holder to the hose clamp 12. The clamp holder 14 is securely attached to the vacuum cleaner body 1 by securing two screws 18 through the screw holes of the clamp holder 14, wherein the other end of the hose clamp 12 is inserted in the air inlet of the vacuum cleaner body 1. Since the hose clamp 12 is locked at the other end of the hose 3 in an inseparable manner from the holder 14, the hose 3 can be securely locked at the air vacuum cleaner body 1. Air and entrained dust are drawn in through the hose 3, which is connected in fluid-communication with the air inlet of the vacuum cleaner body through the hose clamp 12.

As described above, the vacuum cleaner according to the prior art can clean through the hose 3 which is securely attached to the vacuum cleaner body 1 by the hose lock apparatus 10. Since the hose lock apparatus 10 according to the conventional art is locked with two screws 18 at the air vacuum cleaner body 1 after locking the clamp holder 14 to the hose clamp 12, it is inconvenient for a user to assemble the hose 3 to the air vacuum cleaner body 1. In addition, two screws 18 have to be unscrewed to separate the hose 3 from the air cleaner body 1 when it is desired to separate the hose from the air cleaner body, for example, to remove foreign substances from a blocked hose 3. Hence, it is difficult to remove the alien substances. In addition, production cost of the hose lock apparatus for air vacuum cleaners, according to the prior art, is high because the hose lock apparatus includes three separate parts.

Thus, a heretofore unaddressed need exists in the industry to address the aforementioned deficiencies and inadequacies.

### SUMMARY OF THE INVENTION

The present invention solves the above-mentioned problems occurring in the prior art. An object of the present invention is to provide a hose lock apparatus for a vacuum cleaner wherein a user can easily assemble a hose and a vacuum cleaner without requiring screws such that the user can separate the hose from the air cleaner body with convenience, and thereby improve the use and convenience of a vacuum cleaner.

Another object of the present invention is to provide a hose lock apparatus for a vacuum cleaner which requires fewer parts, and is inexpensive in production cost.

In order to achieve the above aspects, a hose lock apparatus is provided for a vacuum cleaner that secures a hose for drawing in dust at an air inlet of the vacuum cleaner body. The hose lock apparatus includes a hose clamp substantially in a hollow cylindrical shape receiving an end of the hose therein, and including a locking protrusion formed along the outer circumference. A clamp holder is securely attached to the air inlet and includes a connecting hole for receiving the hose clamp therein to connect the hose in fluid-communication with the air inlet. An insertion hole in the connecting hole guides insertion of the locking protrusion, and a seating groove receives the locking protrusion therein and is in fluid-communication with the insertion hole. The locking protrusion is fitted in the seating groove and thus, the hose clamp does not separate from the clamp holder while inserting the hose clamp into the connecting hole of the clamp holder and rotating the hose clamp predetermined angles.

The seating groove of the clamp holder may include a rotation prevention rib that prevents the locking protrusion from reversely rotating when the locking protrusion of the hose clamp is received by rotating the protrusion the predetermined angles at the seating groove. At this time, when the locking protrusion of the hose clamp is rotated an angle of 30 degrees, the rotating prevention rib prevents the locking protrusion from reversely rotating. The hose clamp may include two locking protrusions. The hose clamp may further include a cover portion that extends from the end receiving the side of the hose, and covers the clamp holder so as not to be visible from the outside.

The clamp holder may be configured at the rear side of the upright-type vacuum cleaner body and mounted to the air inlet which receives the hose therein, wherein the hose is in fluid-communication with an auxiliary suction brush. The clamp holder may also be securely attached by two screws.

As described above, a hose can be attached to a vacuum cleaner body by inserting the hose clamp into the clamp holder of the vacuum cleaner body and rotating the clamp holder the predetermined angles. Accordingly, it is very simple for a user to attach the hose to the vacuum cleaner body. In addition, when it is necessary to separate the hose from the air cleaner body, for example, to remove foreign substances from a blocked hose, the hose can be separated from the vacuum cleaner body by rotating the hose clamp the predetermined angles in an opposite direction of the attachment. Accordingly, it is convenient to separate the hose from the vacuum cleaner body, and, convenience of using a vacuum cleaner is increased. Since only two parts, the hose clamp and clamp holder, are necessary for locking the hose to the main body, product cost can be decreased.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The above and other aspects, features and advantages of the present invention will be more apparent from the following detailed description taken with reference to the accompanying drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a drawing of a perspective view showing a upright-type vacuum cleaner to which a hose is securely attached by a conventional hose lock apparatus;

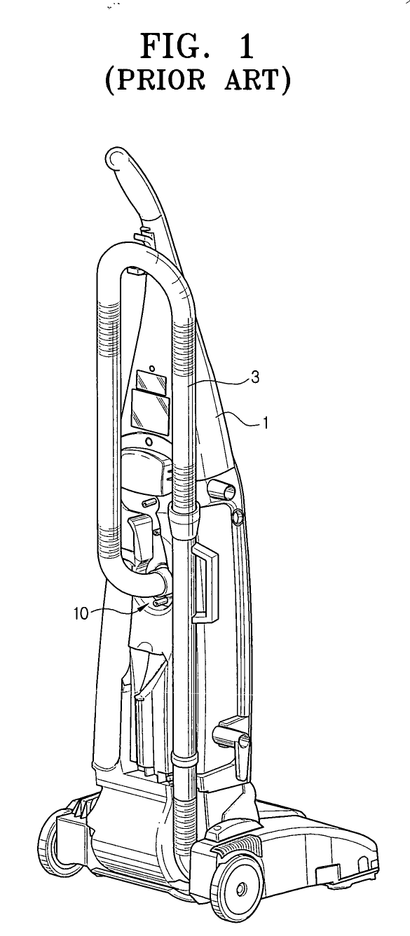

FIG. 2 is a drawing of an exploded perspective view showing an embodiment of the hose lock apparatus for the vacuum cleaner shown in FIG. 1;

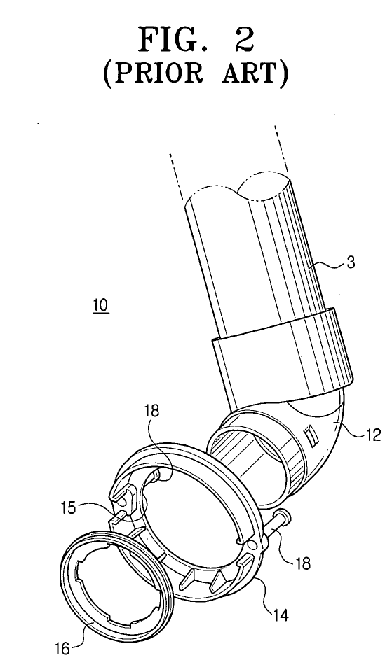

FIG. 3 is a drawing of an exploded perspective view showing a hose lock apparatus for a vacuum cleaner according to an embodiment of the present invention;

FIG. 4 is a drawing of a partial perspective view showing an air inlet of the upright-type vacuum cleaner body;

FIG. 5 is a drawing of a perspective view showing the clamp holder of the hose lock apparatus for the vacuum cleaner shown in FIG. 3 provided at the upright-type vacuum cleaner body shown in FIG. 4;

FIG. 6 is a drawing of a perspective view showing the clamp holder of the hose lock apparatus for the vacuum cleaner shown in FIG. 3;

FIG. 7 is a drawing of a sectional diagram for explaining the relationship between the seating groove of the clamp holder and the locking protrusion of the hose clamp; and

FIG. 8 is a drawing of a perspective view showing a hose clamp of the hose lock apparatus for a vacuum cleaner shown in FIG. 3 assembled to the clamp holder.

### DETAILED DESCRIPTION OF THE EXEMPLARY EMBODIMENTS

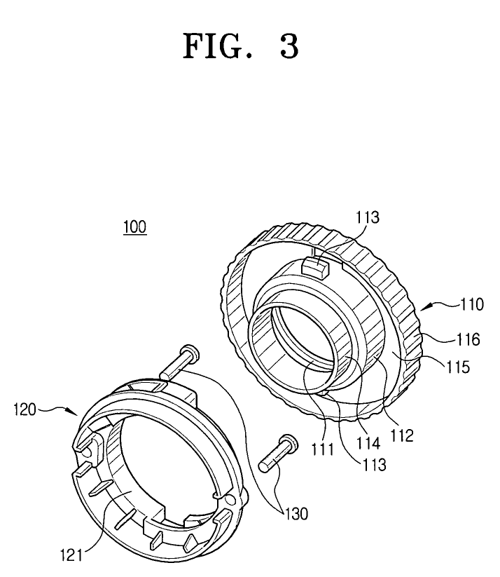

FIG. 3 is an exploded perspective view showing the hose lock apparatus for a vacuum cleaner according to an embodiment of the present invention. The hose lock apparatus 100 includes a hose clamp 110 securely attached to an end of a hose (not shown), and a clamp holder 120 provided at the vacuum cleaner body 1. The hose clamp 110 is formed in a cylindrical shape with an inside 111 securely attaching to the end of the hose. The hose clamp 110 includes a locking protrusion 113 on the outer circumference thereof. The locking protrusion 113 holds the hose clamp 110 at a clamp holder 120 from separating from the clamp holder 120. One locking protrusion 113 can be configured, although two are preferred. In the present embodiment, two locking protrusions 113 are configured at intervals of 180 degrees. An insertion part 114 is configured at the one side of the hose clamp 110 with a size corresponding to an air inlet of the vacuum cleaner body 1. A cover portion 115 is preferably configured by extending the other end of the hose clamp 110, i.e., extending the end receiving the hose, so that the cover portion covers the clamp holder 120 from exterior view. The cover portion 115 is bent and is extended towards the direction of the hose clamp 110 insertion to the vacuum cleaner body 1, and has groove 116 formed in the outer circumference of the hose clamp 110 such that the hose clamp 110 can be conveniently attached to, and separated from, the clamp holder 120. Various methods may be employed for locking the hose to the hose clamp 110. For example, the hose can be secured to the inside 111 of the hose clamp 110 by adhesives or screws by configuring female screws at the inside 111 of the hose clamp 110 and male screws at the end of the hose.

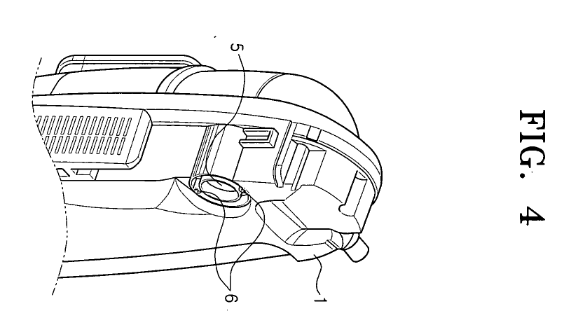

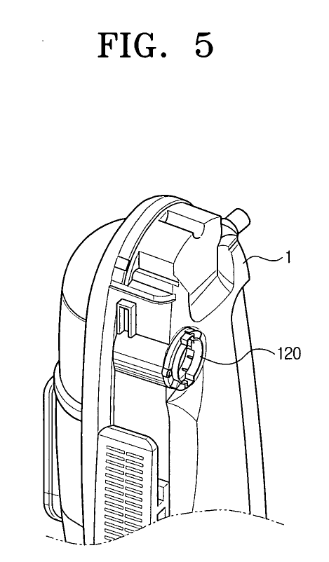

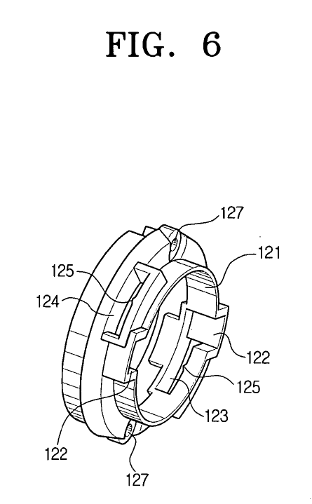

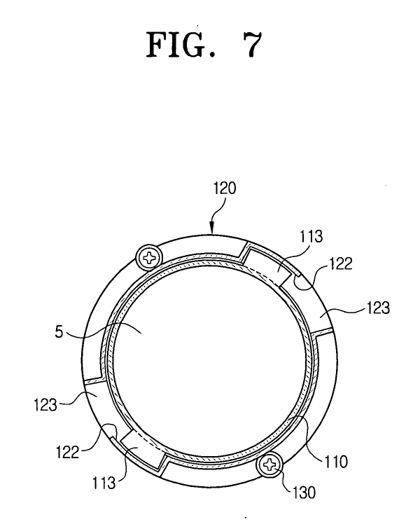

The clamp holder 120 holds the hose clamp 110 to prevent separation from the vacuum cleaner body and is provided at the air inlet 5 of the vacuum cleaner body 1 as shown in FIG. 4. FIG. 5 shows that the clamp holder 120 is provided at the vacuum cleaner body 1. Referring to FIG. 6, the clamp holder 120 includes a connecting hole 121 formed at the center in fluid-communication with the air inlet 5. The connecting hole 121 is adjoined with axially-spaced depressions 122 and axially-spaced seating groove 123 for secure insertion of the locking protrusion 113 of the hose clamp 110. The axially-spaced depressions 122 are extended in the clamp holder 120 in the shapes and numbers corresponding to those of the locking protrusions 113 of the hose clamp 110. The seating grooves 123 are connected to the axially-spaced depressions 122. The seating grooves 123 are formed in the circumferential direction of the clamp holder 120 corresponding in shape to the locking protrusion 113 for the hose clamp 110 so that the hose clamp 110 does not separate in the inserting direction. Accordingly, the locking protrusion 113 is positioned in the seating groove 123 by fitting the locking protrusions 113 to the axially-spaced depressions 122, inserting the hose clamp 110 into the connecting hole 121 of the clamp holder 120, and then rotating the hole clamp 110 by predetermined angles along the seating groove 123 in the lower part of the axially-spaced depressions 122. As a result, the hose clamp 110 is securely engaged with the clamp holder 120. A rotating prevention rib 125 is provided at one side of the seating groove 123 in contact with the locking protrusion 113 of the hose clamp 110. The rotating prevention rib 125 is configured such that, when a user grabs and rotates the hose clamp 110, the locking protrusion 113 can be rotated in the seating groove 123. However, when the user grabs the hose for work such as cleaning, the locking protrusion 113 does not reversely rotate in the seating groove 123 by a force applied to the hose clamp 110. The rotating prevention rib 125 is formed preferably at the position where the locking protrusion 113 is locked in the seating groove 123 when rotating the hose clamp 110 by angles of approximately 30 degrees. A bottom side of the seating groove 123 includes a piercing hole 127 for convenience in shaping the hose clamp 110. Since two of the locking protrusions 113 of the hose clamp 110 are formed by angles of 180 degrees, two of each of the axially-spaced depressions 122 and the seating groove 123 of the clamp holder 120 are formed of angles of 180 degrees corresponding to the locking protrusion 113. FIG. 7 illustrates a state when the hose clamp 110 is inserted into the clamp holder 120 and the locking protrusion 113 is positioned in the placed groove 122.

A plurality of passing holes 127 (FIG. 6) are formed at the outside of the connecting hole 121 of the clamp holder 120 for locking the clamp holder 120 to the vacuum cleaner body 1 by using appropriate fasteners, such as screws. A plurality of tap holes 6 (FIG. 4) are formed around the air inlet 5 of the vacuum cleaner body 1, corresponding to the piercing holes 127 of the clamp holder 120. Since two of each of the piercing holes 127 and tap holes 6 are formed, the clamp holder 120 is securely attached to the vacuum cleaner body 1 by two screws 130 as shown FIG. 7.

Hereinafter, operation of the hose lock apparatus for vacuum cleaners according to the present invention is described in detail with reference to the accompanying drawings.

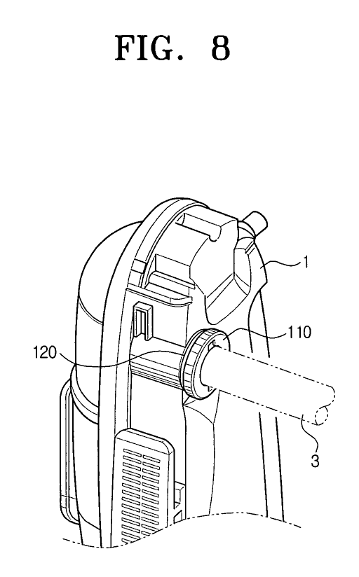

The clamp holder 120 is fastened to the air inlet 5 of the vacuum cleaner body 1 by the two screws 130. FIG. 5 illustrates a state when the clamp holder 120 is provided at the vacuum cleaner body 1. The hose clamp 110 is securely attached to an end of the hose 3 (FIG. 8). If a female screw (not shown) is formed at the inside 111 of the hose clamp 110 and a male screw (not shown) is formed at the end of the hose 3, the hose clamp 110 is connected to the end of the hose 3 by coupling the male and female screws.

The locking protrusions 113 of the hose clamp 110 are aligned with the axially-spaced depressions 122 of the clamp holder 120, and the insertion part 114 of the hose clamp 110 is urged into the connecting hole 121 of the clamp holder 120. When the locking protrusion 113 of the hose clamp 110 contacts the lower part of the axially-spaced depressions 122, the locking protrusion 113 of the hose clamp 110 is positioned in the seating groove 123 by rotating clock-wise the hose clamp 110 towards a predetermined direction by angles of approximately 30 degrees. The hose 3 is attached to the vacuum cleaner body 1 as shown in FIG. 8. When the rotating prevention rib 125 (FIG. 6) is configured at the seating groove 123 of the clamp holder 120, the rotating prevention rib 125 enables the locking protrusion 113 to firmly attach to the seating groove 123. Therefore, even though a user grabs the hose for cleaning works, the hose clamp 110 does not rotate in reverse and separate from the clamp holder 120. In addition, when the cover portion 115 is configured at the other end of the hose clamp 110, the hose clamp 110 can be conveniently attached to, and separated from, the clamp holder 120 by the user. Thus, the appearance is better because the cover portion 115 of the hose clamp 110 covers the clamp holder 120.

When it is desired to separate the hose 3 from the clamp holder 120 of the vacuum cleaner body 1, the hose 3 can be easily separated by rotating the hose clamp 110 in an opposite direction of the attachment by angles of about 30 degrees, counterclockwise, and pulling the hose clamp 110 in an axial direction of the clamp holder 120.

Additional advantages, objects, and features of the embodiments of the invention will be set forth in part in the description which follows and in part will become apparent to those having ordinary skill in the art upon examination of the following, or may be learned from practice of the invention. The objects and advantages of the embodiments of the invention may be realized and attained as particularly pointed out in the appended claims.

1. A hose lock apparatus for a vacuum cleaner which secures a hose for drawing in dust to an air inlet configured at the vacuum cleaner body, comprising:
a hose clamp substantially in a hollow cylindrical shape, receiving an end of the hose therein and including a locking protrusion formed along an outer circumference; and
a clamp holder securely attached to the air inlet, including a connecting hole for receiving the hose clamp therein to connect in fluid-communication the hose and the air inlet, an insertion hole in the connecting hole guiding insertion of the locking protrusion, and a seating groove receiving the locking protrusion therein and in fluid-communication with the insertion hole,
wherein the locking protrusion is fitted in the seating groove and thereby, the hose clamp does not separate from the clamp holder when inserting the hose clamp into the connecting hole of the clamp holder and rotating the hose clamp predetermined angles.

2. The hose lock apparatus according to claim 1, wherein the seating groove of the clamp holder comprises:
a rotation prevention rib which prevents the locking protrusion from reversely rotating when the locking protrusion of the hose clamp is received by rotating the protrusion the predetermined angles at the seating groove.

3. The hose lock apparatus according to claim 2, wherein the rotation prevention rib prevents the protrusion from rotating in reverse when the locking protrusion of the hose clamp is rotated in angles of 30 degrees.

4. The hose lock apparatus according to claim 2, wherein the hose clamp comprises two locking protrusions.

5. The hose lock apparatus according to claim 4, wherein the hose clamp further comprises a cover portion which is extended from the end receiving the side of the hose, and covers the clamp holder preventing exterior visibility.

6. The hose lock apparatus according to claim 5, wherein the clamp holder is configured at the rear side of the upright-type vacuum cleaner body, and is mounted to the air inlet which receives the hose therein, wherein the hose is in fluid-communication with an auxiliary suction brush.

7. The hose lock apparatus according to claim 1, wherein the clamp holder is securely attached via two screws.
